(19) United States
(12) Patent Application Publication
(10) Pub. No.: US 2018/0242395 A1
(43) Pub. Date: Aug. 23, 2018

(54) Method System and Apparatus

(71) Applicant: Nokia Solutions and Networks Oy, Espoo (FI)

(72) Inventors: Srinivasan Selvaganapathy, Bangalore (IN); Seppo Vesterinen, Kuopio (FI); Xiang Xu, Nanjing, Jiangsu (CN); Tsunehiko Chiba, Saitama (JP)

(21) Appl. No.: 15/751,347

(22) PCT Filed: Jul. 22, 2016
(86) PCT No.: PCT/FI2016/050538

§ 371 Date: Feb. 8, 2018

(30) Foreign Application Priority Data
Aug. 14, 2015 (IN) 4247/CHE/2015

(51) Int. Cl. H04W 88/16; H04W 48/20; H04W 76/12; H04W 76/22; H04W 88/10; H04W 88/12; H04W 88/18

(52) U.S. Cl. CPC H04W 88/16; H04W 48/20; H04W 76/12; H04W 88/14; H04W 88/10; H04W 88/12; H04W 88/182; H04W 76/22

(57) ABSTRACT

There is provided a method comprising receiving information, at a node of a core network, said information comprising an indication of a first local gateway suitable for providing connectivity to a user equipment, wherein the first local gateway is collocated with a first secondary access point, receiving a request from the user equipment for a packet data network connection, upon the request, using said information to select the first local gateway for providing connectivity to the user equipment and providing an indication of the first local gateway to a master access point.

### FIELD

The present application relates to a method, apparatus and system and in particular but not exclusively, to local breakouts in a Heterogeneous network with 4G and 5G radio-nodes.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases.

### SUMMARY OF THE INVENTION

In a first aspect there is provided a method comprising receiving information, at a node of a core network, said information comprising an indication of a first local gateway suitable for providing connectivity to a user equipment, wherein the first local gateway is collocated with a first secondary access point, receiving a request from the user equipment for a packet data network connection, upon the request, using said information to select the first local gateway for providing connectivity to the user equipment and providing an indication of the first local gateway to a master access point.

The method may comprise storing said information at the node of the core network at least until the request is received.

The method may comprise storing user context associated with the user equipment at the node of the core network at least until the request is received.

The information may comprise mobility information associated with the user equipment.

The indication of the local gateway may comprise an IP address.

The first secondary access point may be a 5G access point.

The method may comprise receiving said information from at least one of the master access point and a second local gateway.

The second local gateway may be collocated with one of the master access point and a second secondary access point.

The method may comprise receiving a request to offload at least a part of the data communication from the second local gateway, wherein the user equipment has a packet data network connection to be offloaded to the first secondary access point from the access point collocated with the second local gateway.

The indication of a local gateway may comprise an identifier of a local gateway acting as a proxy and an identifier of the local gateway behind the proxy.

The request from the user equipment for a packet data network connection may be a request for a packet data network reactivation or reattach.

In a second aspect there is provided a method comprising determining, at a master access point, a first local gateway suitable for providing connectivity to a user equipment, wherein the first local gateway is collocated with a first secondary access point and providing information to a node of the core network for use in selecting a local gateway upon a request from the user equipment for a packet data network connection, said information comprising an indication of the determined first local gateway.

The method may comprise providing information to a second local gateway providing connectivity to the user equipment, said information comprising an indication of the determined first local gateway.

The information provided to the second local gateway may comprise a trigger to offload at least part of a data communication with the user equipment to the determined first local gateway.

The second local gateway may be collocated with one of the master access point and a second secondary access point.

The user equipment may have a packet data network connection to be offloaded to the first secondary access point from the access point collocated with the second local gateway.

The information provided to the node of the core network may comprise mobility information associated with the user equipment.

The indication of the determined local gateway may comprise an IP address.

The indication of the determined local gateway may comprise an identifier of a local gateway acting as a proxy and an identifier of the first local gateway behind the proxy.

The first secondary access point may be a 5G access point.

The request from the user equipment for a packet data network connection may be a request for a packet data network reactivation or reattach.

In a third aspect there is provided an apparatus, said apparatus comprising means for receiving information, at a node of a core network, said information comprising an indication of a first local gateway suitable for providing connectivity to a user equipment, wherein the first local gateway is collocated with a first secondary access point, means for receiving a request from the user equipment for a packet data network connection, upon the request, means for using said information to select the first local gateway for providing connectivity to the user equipment and means for providing an indication of the first local gateway to a master access point.

The apparatus may comprise means for storing said information at the node of the core network at least until the request is received.

The apparatus may comprise means for storing user context associated with the user equipment at the node of the core network at least until the request is received.

The information may comprise mobility information associated with the user equipment.

The indication of the local gateway may comprise an IP address.

The first secondary access point may be a 5G access point.

The apparatus may comprise means for receiving said information from at least one of the master access point and a second local gateway.

The second local gateway may be collocated with one of the master access point and a second secondary access point.

The apparatus may comprise means for receiving a request to offload at least a part of the data communication from the second local gateway, wherein the user equipment has a packet data network connection to be offloaded to the first secondary access point from the access point collocated with the second local gateway.

The indication of a local gateway may comprise an identifier of a local gateway acting as a proxy and an identifier of the local gateway behind the proxy.

The request from the user equipment for a packet data network connection may be a request for a packet data network reactivation or reattach.

In a fourth aspect there is provided an apparatus, said apparatus comprising means for determining, at a master access point, a first local gateway suitable for providing connectivity to a user equipment, wherein the first local gateway is collocated with a first secondary access point and means for providing information to a node of the core network for use in selecting a local gateway upon a request from the user equipment for a packet data network connection, said information comprising an indication of the determined first local gateway.

The apparatus may comprise means for providing information to a second local gateway providing connectivity to the user equipment, said information comprising an indication of the determined first local gateway.

The information provided to the second local gateway may comprise a trigger to offload at least part of a data communication with the user equipment to the determined first local gateway.

The second local gateway may be collocated with one of the master access point and a second secondary access point.

The user equipment may have a packet data network connection to be offloaded to the first secondary access point from the access point collocated with the second local gateway.

The information provided to the node of the core network may comprise mobility information associated with the user equipment.

The indication of the determined local gateway may comprise an IP address.

The indication of the determined local gateway may comprise an identifier of a local gateway acting as a proxy and an identifier of the first local gateway behind the proxy.

The first secondary access point may be a 5G access point.

The request from the user equipment for a packet data network connection may be a request for a packet data network reactivation or reattach.

in a fifth aspect, there is provided an apparatus comprising at least one processor and at least one memory including a computer program code, the at least one memory and the computer program code configured to, with the at least one processor, cause the apparatus at least to receive information, at a node of a core network, said information comprising an indication of a first local gateway suitable for providing connectivity to a user equipment, wherein the first local gateway is collocated with a first secondary access point, receive a request from the user equipment for a packet data network connection, upon the request, use said information to select the first local gateway for providing connectivity to the user equipment and provide an indication of the first local gateway to a master access point.

The apparatus may be configured to store said information at the node of the core network at least until the request is received.

The apparatus may be configured to store user context associated with the user equipment at the node of the core network at least until the request is received.

The information may comprise mobility information associated with the user equipment.

The indication of the local gateway may comprise an IP address.

The first secondary access point may be a 5G access point.

The apparatus may be configured to receive said information from at least one of the master access point and a second local gateway.

The second local gateway may be collocated with one of the master access point and a second secondary access point.

The apparatus may be configured to receive a request to offload at least a part of the data communication from the second local gateway, wherein the user equipment has a packet data network connection to be offloaded to the first secondary access point from the access point collocated with the second local gateway.

The indication of a local gateway may comprise an identifier of a local gateway acting as a proxy and an identifier of the local gateway behind the proxy.

The request from the user equipment for a packet data network connection may be a request for a packet data network reactivation or reattach.

In a sixth aspect there is provided an apparatus comprising at least one processor and at least one memory including a computer program code, the at least one memory and the computer program code configured to, with the at least one processor, cause the apparatus at least to determine, at a master access point, a first local gateway suitable for providing connectivity to a user equipment, wherein the first local gateway is collocated with a first secondary access point and provide information to a node of the core network for use in selecting a local gateway upon a request from the user equipment for a packet data network connection, said information comprising an indication of the determined first local gateway.

The apparatus may be configured to provide information to a second local gateway providing connectivity to the user equipment, said information comprising an indication of the determined first local gateway.

The information provided to the second local gateway may comprise a trigger to offload at least part of a data communication with the user equipment to the determined first local gateway.

The second local gateway may be collocated with one of the master access point and a second secondary access point.

The user equipment may have a packet data network connection to be offloaded to the first secondary access point from the access point collocated with the second local gateway.

The information provided to the node of the core network may comprise mobility information associated with the user equipment.

The indication of the determined local gateway may comprise an IP address.

The indication of the determined local gateway may comprise an identifier of a local gateway acting as a proxy and an identifier of the first local gateway behind the proxy.

The first secondary access point may be a 5G access point.

The request from the user equipment for a packet data network connection may be a request for a packet data network reactivation or reattach.

In a seventh aspect there is provided a computer program embodied on a non-transitory computer-readable storage medium, the computer program comprising program code for controlling a process to execute a process, the process comprising receiving information, at a node of a core network, said information comprising an indication of a first local gateway suitable for providing connectivity to a user equipment, wherein the first local gateway is collocated with a first secondary access point, receiving a request from the user equipment for a packet data network connection, upon the request, using said information to select the first local gateway for providing connectivity to the user equipment and providing an indication of the first local gateway to a master access point.

The process may comprise storing said information at the node of the core network at least until the request is received.

The process may comprise storing user context associated with the user equipment at the node of the core network at least until the request is received.

The information may comprise mobility information associated with the user equipment.

The indication of the local gateway may comprise an IP address.

The first secondary access point may be a 5G access point.

The process may comprise receiving said information from at least one of the master access point and a second local gateway.

The second local gateway may be collocated with one of the master access point and a second secondary access point.

The process may comprise receiving a request to offload at least a part of the data communication from the second local gateway, wherein the user equipment has a packet data network connection to be offloaded to the first secondary access point from the access point collocated with the second local gateway.

The indication of a local gateway may comprise an identifier of a local gateway acting as a proxy and an identifier of the local gateway behind the proxy.

The request from the user equipment for a packet data network connection may be a request for a packet data network reactivation or reattach.

In an eighth aspect there is provided a computer program embodied on a non-transitory computer-readable storage medium, the computer program comprising program code for controlling a process to execute a process, the process comprising providing information to a second local gateway providing connectivity to the user equipment, said information comprising an indication of the determined first local gateway.

The process may comprise providing information to a second local gateway providing connectivity to the user equipment, said information comprising an indication of the determined first local gateway.

The information provided to the second local gateway may comprise a trigger to offload at least part of a data communication with the user equipment to the determined first local gateway.

The second local gateway may be collocated with one of the master access point and a second secondary access point.

The user equipment may have a packet data network connection to be offloaded to the first secondary access point from the access point collocated with the second local gateway.

The information provided to the node of the core network may comprise mobility information associated with the user equipment.

The indication of the determined local gateway may comprise an IP address.

The indication of the determined local gateway may comprise an identifier of a local gateway acting as a proxy and an identifier of the first local gateway behind the proxy.

The first secondary access point may be a 5G access point.

The request from the user equipment for a packet data network connection may be a request for a packet data network reactivation or reattach.

In a ninth aspect there is provided a computer program product for a computer, comprising software code portions for performing the steps the method of the first aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a communication system for offloading SIPTO@LN data traffic to Internet;

FIG. 4 shows a communication system with an MeNB collocated L-GW proxy function;

FIG. 5 shows a flowchart of an example method for local breakout;

FIG. 6 shows a flowchart of an example method for local breakout;

FIG. 7 shows a messaging flow for switching PDN connection;

FIG. 8 shows a schematic diagram of an example control apparatus;

### DETAILED DESCRIPTION

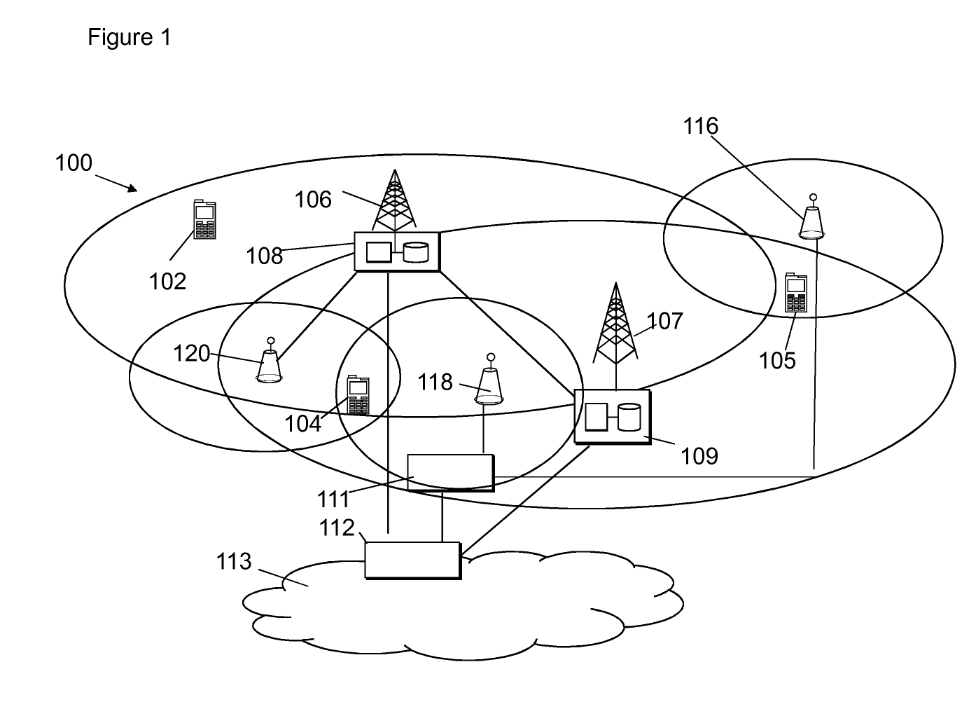

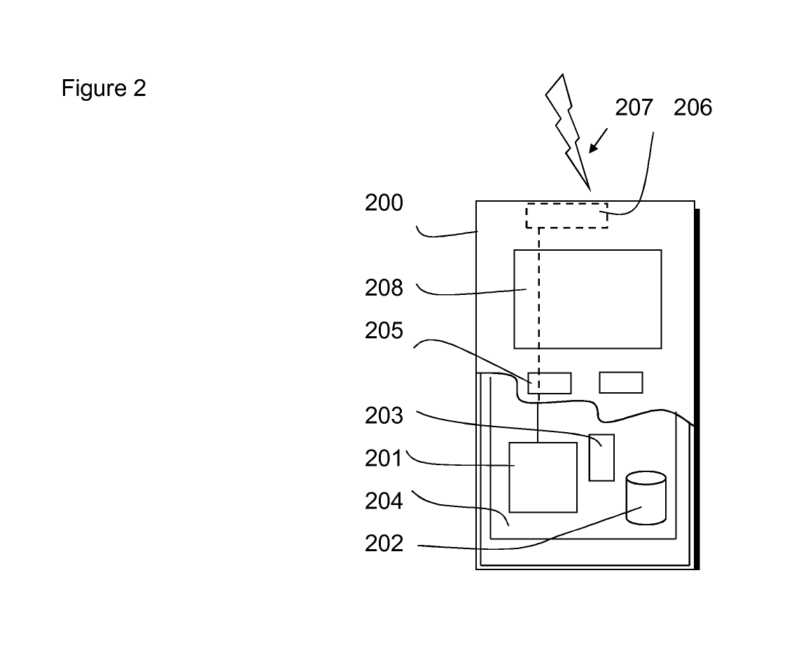

Before explaining in detail the examples, certain general principles of a wireless communication system and mobile communication devices are briefly explained with reference to FIGS. 1 to 2 to assist in understanding the technology underlying the described examples.

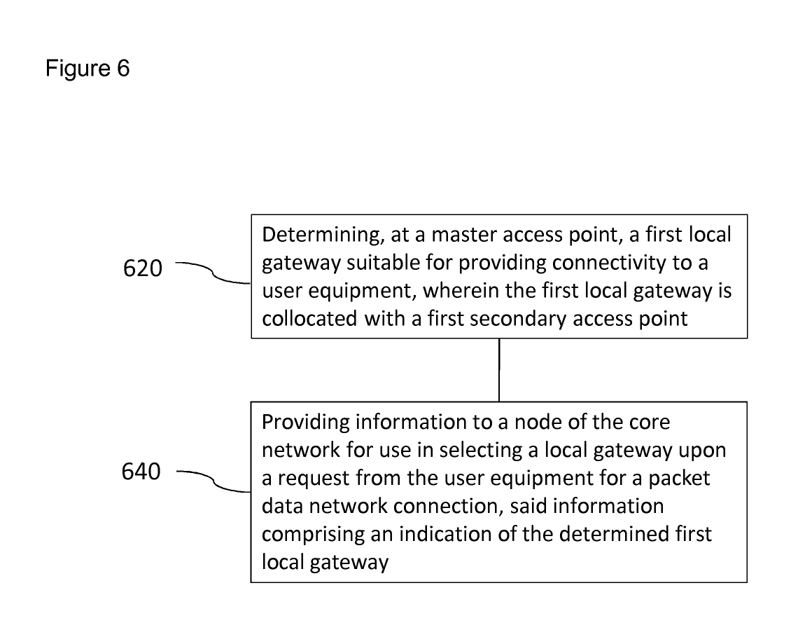

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 6.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be collocated.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

Cellular systems may be highly centralized and hierarchical, forcing user traffic to traverse up to the core, where centralized mobile gateways are deployed to function as border IP gateways and mobility anchors. Local service is becoming popular for multiple reasons, e.g. shorter delay due to the local routing, reduced pressure on CN and its backhaul, etc. Where local gateways are supported in existing LTE networks in the form of local breakouts, such as SIPTO or LIPA, the change of IP gateway for a user from one node to another node may involve more signalling, both between the device and network and within network, and also data interruption.

In 5G heterogeneous networks deployed with macro nodes , e.g. LTE eNBs, and small cell nodes of higher frequency (mmWave and cmWave), it may be desirable to change the IP Gateway anchor of a user, or specific bearers of a user, between 4G L-GWs and 5G L-GWs more quickly to enable lower latency data transfer via new IP gateways. The local breakout, a mechanism where roaming traffic does not traverse back to the home network but is handled by the local operator, may be beneficial.

Dual connectivity (DC) was introduced to provide better UE throughput experience in Release 12. In DC, primary access points and secondary access points may be defined as master eNBs (MeNBs) and secondary eNBs (SeNBs). In 5G, multi-connectivity may provide higher throughput and traffic offload to the 5G network.

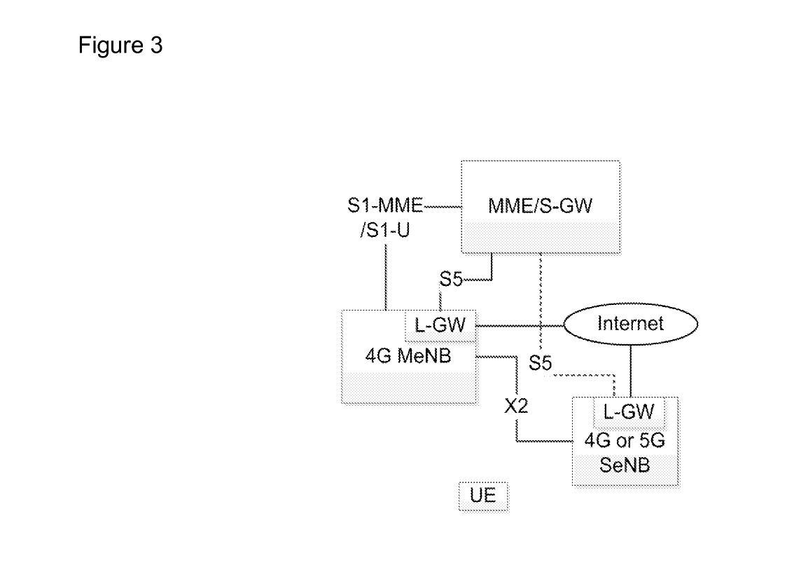

FIG. 3 shows a schematic diagram of a communications system in which SIPTO@LN data traffic to the internet is offloaded via a 4G MeNB and 4G or 5G SeNB collocated L-GWs. In 5G networks, where macro coverage may be provided by LTE nodes and capacity offloading may be provided by a 5G AP, the L-GW change for SIPTO@LN services from 4G L-GW to 5G L-GW may happen for a number of reasons.

Users having an RRC connection and SIPTO@LN data traffic offloading via an LTE node, and the 4G L-GW associated with the LTE node, may move towards 5G-AP with collocated L-GW. Alternatively or in addition to, an operator may move a user with multi-connectivity connected to a 4G-AP to a 5G-AP to reduce the backhaul traffic and resources used in the 4G-AP.

In such scenarios, as per existing LTE based design, a secondary radio connection is established, followed by the deactivation of the local breakout packet data network (PDN) connection via 4G-L-GW and re-establishment of the local breakout PDN connection via 5G-L-GW. When the 4G L-GW initiates the deactivation, the MME releases the PDN context and thus radio connection (RRC) is also released. Due to this behaviour, on reception of a PDN reactivation request, MeNB will provide by default its collocated L-GW IP Address in S1 message thus the IP session will again be established via 4G-L-GW instead of offloading the traffic via the 5G-L-GW.

It is possible that only the radio bearer may be offloaded to 5G-AP via multi-connectivity without changing the L-GW, i.e. the 4G-L-GW still handles the internet traffic. If L-GW is overloaded, for some bearers to be switched from 4G L-GW to 5G L-GW, the 4G L-GW may trigger the above method of deactivation and reactivation. As part of re-activation, MeNB may not know whether to include its own collocated 4G L-GW-IP Address or the 5G-L-GW IP-Address in the S1 message for offloading, thus, a reactivation of PDP context with same L-GW may result.

These problems may be resolved with additional changes at 4G L-GW and MME as part of the IP session switching.

One approach to specify LIPA (local IP access) or SIPTO@LN (selective IP traffic offload at local network) service support via a 4G SeNB collocated L-GW may be the Small Cell Architecture option 1A in 3GPP, applied for routing user bearer traffic (IP packets) directly out of a SeNB. This option may require a full radio stack in a SeNB, including packet data convergence protocol (PDCP). For example, X2 application protocol (X2AP) extensions may be specified for managing the LIPA or SIPTO@LN bearers that are offloaded via a SeNB (the bearer management signalling may indicate how a SeNB should route the offloaded bearer traffic e.g. to MeNB over X2-u, to S-GW with direct tunnel by-passing MeNB or to a L-GW). The SeNB may report over the X2 interface the availability of its collocated L-GW to the MeNB and transfer the IP address of the L-GW for S5 control interface and Local Network Identifier (MeNB needs this information to be sent to the MME when a SIPTO@LN bearer service is established). The MeNB may be able to differentiate LIPA or SIPTO@LN bearer from the ordinary E-RABs (MME is controlling E-RABs over the S1-MME interface) and decide offloading is to be done via a SeNB collocated L-GW.

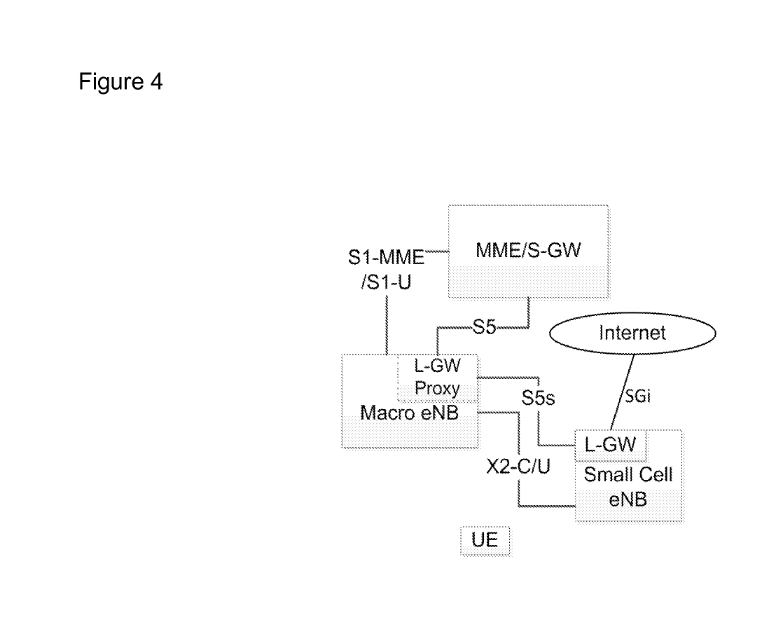

FIG. 4 shows a MeNB collocated L-GW proxy function used to hide a number of SeNB collocated L-GWs behind a single S5 interface from the S-GW. The L-GW Proxy function may relay the S5 control messages (GTP protocol messages in downlink) received from the S-GW to the SeNB/L-GW over the X2 interface. That is, the S5 interface is extended from MeNB to the L-GW over the X2 interface, shown as S5s in FIG. 4. Correspondingly the MeNB collocated L-GW Proxy function may relay the S5 control message replies (GTP protocol messages in uplink) from the L-GW to the S-GW. In order to handle numerous L-GWs in the SeNBs with help of a L-GW Proxy, the MeNB may implement the dual connectivity management functions as required for SCE architecture option 1A with full radio stack in SeNBs in order to enable an offloaded SCG bearer to be used as SIPTO@LN bearer service via the SeNBs. The S5 control interface from the S-GW serving the UE (located at the EPC) used to control the L-GW for SIPTO@LN service shall be terminated at the serving MeNB of the UE i.e. where also the S1-MME interface is terminated. In its S5 control interface termination point the MeNB may implement a collocated L-GW Proxy function that emulates and hides the actual L-GWs that are collocated in the SeNBs. The L-GW proxy may manage the relaying of the extended S5 interface over the X2 by performing the required TNL address (IP Address) and GTP TEID (Tunnel Endpoint Identifier) value translations. The MeNB may advertise to the EPC only the IP address of its collocated L-GW Proxy function, i.e. the actual IP addresses of the SeNB collocated L-GWs remain at RAN level. The SeNB may report over the X2 interface availability of its collocated L-GW to the MeNB and transfer the IP address of the SeNB collocated L-GW control interface and Local Network Identifier. X2AP extensions for managing the SCG bearers that are offloaded via a SeNB may be specified (the bearer management signalling may indicate how the SeNB should route the offloaded SCG bearer traffic, e.g. to MeNB over X2-u, to S-GW with direct tunnel by-passing MeNB or to a L-GW with help of Correlation ID). The MeNB may differentiate SIPTO@LN bearer from the ordinary E-RABs (MME is controlling E-RABs over the S1-MME interface) and decide that offloading is to be done via the SeNB collocated L-GW. When a SCG Bearer for SIPTO@LN service via the SeNB collocated L-GW is released, then the MeNB may provide an indication to the SeNB to let it trigger PDN connection release in its collocated L-GW.

This option does not specify how the MeNB is able to identify that the received S1 E-RAB setup for LIPA or SIPTO@LN PDN connection intends to use either the MeNB collocated L-GW or an SeNB collocated L-GW for reactivations.

The following relates to efficient use of the local breakout in a mixed 4G/5G network. More specifically, the following relates to switching of local breakout data traffic from L-GW connected to macro-4G node to L-GW connected to 5G-AP. The following is described with reference to a UE capable for dual connectivity (DC) and enabled with local breakout service (e.g. SIPTO@LN, or LIPA) in the UE's subscription. While in the connected mode, such a UE may become served by an eNB that may, or may not have a collocated L-GW and that is operating as a MeNB for the 4G or 5G SeNB(s) having collocated L-GWs.

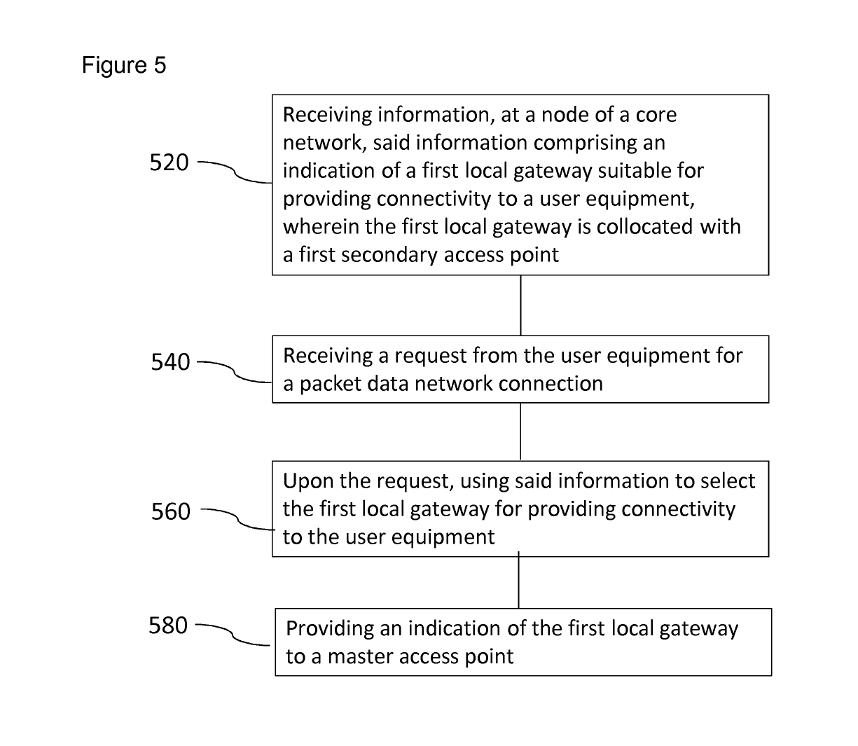

FIG. 5 shows a flowchart of an example method for local breakout. The method comprises, in step 520 receiving information, at a node of a core network, said information comprising an indication of a first local gateway suitable for providing connectivity to a user equipment, wherein the first local gateway is collocated with a first secondary access point.

In step 540, the method comprises receiving a request from the user equipment for a packet data network connection.

In step 560, the method comprises using said information upon the request to select the first local gateway for providing connectivity to the user equipment.

In step 580, the method comprises providing an indication of the first local gateway to a master access point.

FIG. 6 shows a flowchart of an example method for local breakout which may be performed at a master access point, e.g. an MeNB. Steps include determining 620 at a master access point, a first local gateway suitable for providing connectivity to a user equipment, wherein the first local gateway is collocated with a first secondary access point.

Step 640 comprises providing information to a node of the core network for use in selecting a local gateway upon a request from the user equipment for a packet data network connection, said information comprising an indication of the determined first local gateway.

The node of the core network may be the MME. The first L-GW may be collocated with a 5G AP.

The information may be stored at the node of the core network at least until the request is received. User context associated with the user equipment may be stored at the node of the core network at least until the request is received.

The information may comprises mobility information associated with the user equipment. The indication of the local gateway may comprises an IP address, i.e. a L-GW IP address. Providing connectivity to the user equipment may comprise s PDN connection activated via the determined L-GW.

In an embodiment, the local breakout service activation may be MME initiated via a SeNB collocated L-GW. The UE may be capable of dual connectivity (DC) or multi-connectivity.

In one embodiment, when a MeNB detects that a DC capable UE may obtain radio link connectivity via a SeNB with a collocated L-GW, it informs the MME about new available L-GW in the SeNB. For the informing, the MeNB may use a UE dedicated S1AP message. In addition, the MeNB may provide UE Mobility information (static/slow/fast moving) to the MME. In case of LIPA the MeNB may inform the MME also of the close subscriber group (CSG) ID. The MME saves the L-GW information and determines whether the new available L-GW is suitable to be used for local breakout service.

The request from the user equipment for a packet data network connection may be a request for a packet data network (PDN) reactivation or reattach. If a UE already has a local breakout PDN connection activated via another L-GW, or the UE already has a PDN connection for local breakout service including SIPTO at the local network or LIPA, the MME may initiate a PDN deactivation with a reactivation request. Otherwise, if the UE only has one PDN connection, the MME may initiate a detach with a reattach required.

When a UE either requests a new local breakout PDN connection, or is re-attaching, the MME knows whether this is due to reactivation or reattach. As a consequence, the MME may use the saved SeNB L-GW for the PGW and then issue a Create Session Request to the S-GW, and to the SeNB collocated L-GW, to configure UE P-GW context and to obtain the correlation ID accordingly. The Correlation ID shall bind the user context/instance in the SeNB collocated L-GW with the radio access related user context/instance in the SeNB. A link between these is required as core network is controlling the L-GW functions in the SeNB, and the MenB is controlling the radio access specific functions transparently to each other.

The MME may issue E-RAB setup procedure in which it provides the MeNB with the correlation ID to indicate that the bearer is a local breakout bearer. Also the L-GW-IP-Address is given along with correlation-ID to the MeNB (master radio-node) to identify the SeNB (secondary node).

In an embodiment, local breakout L-GW change may be initiated by the MeNB via a collocated L-GW. The information may be received for a second local gateway. The second local gateway may be collocated with a master access point, e.g. MeNB or a secondary access point, e.g. 4G SeNB.

When a MeNB is serving the UE with existing local breakout E-RAB service and detects that a DC capable UE may obtain radio link connectivity via a new SeNB with a collocated L-GW, the MeNB may decide to offload local breakout services from the MeNB collocated L-GW, or from the current SeNB L-GW to the new SeNB L-GW.

If the current L-GW is the MeNB collocated L-GW, the MeNB (as the master radio node) may trigger SIPTO@LN PDN connection de-activation via internal signalling to its collocated L-GW and give indication about the new L-GW.

If the current L-GW is a SeNB collocated L-GW, the MeNB may command the SeNB by using X2AP message to let the SeNB to trigger local breakout PDN connection deactivation to its collocated L-GW and give indication about the new L-GW.

The collocated L-GW initiates a message towards SGW and to MME node to switch the SIPTO@LN PDN connection on reactivation to a new L-GW Node. This message may be called a S5-L-GW-Switch, including, e.g. PDN-connection-details, new L-GW-IP-Address and optionally L-GW ID (in case of proxying). Alternatively, the collocated L-GW may initiate bearer deactivation procedure with the “reactivation requested” cause value, as well as the new L-GW-IP-Address and, optionally, the L-GW ID.

The MME triggers PDN deactivation towards the UE and the MeNB (or master radio-node in DC), but instead of moving the session to idle state, the MME may keep the UE session where it waits for reactivation with minimum information on the context stored.

On reception of reactivation request for the PDN connection which is already stored, the MME initiates the S5 setup to the new L-GW received, as described in the above step. The MME may also indicates the L-GW-IP-Address and optional L-GW ID along with correlation-Id to the master radio-node to identify the secondary node.

The indication of the determined local gateway may comprise an identifier of a local gateway acting as a proxy and an identifier of the first local gateway behind the proxy. In one embodiment, more than one small-cell nodes are aggregated via a small-cell controller. In such scenarios, the small-cell controller may have an L-GW-Proxy to hide the S5 control plane interface of the small-cells connected to the small-cell controller. In this case, the MeNB may provide a new L-GW-IP-Address and, additionally, an identifier to identify the L-GW node connected behind the L-GW-IP-Address. The L-GW provides new L-GW-IP-Address and the additional identifier to reach the L-GW node behind proxy in S5-L-GW-Switch message to the MME. The MME may use the information received in to proceed with deactivation followed by reactivation.

The L-GW Proxy may also provide 4G-5G inter-working function that converts any possible 4G L-GW UE context to 5G L-GW UE context and communicates with the 5G L-GW by using 5G access specific control protocol instead of S5 (GTP-c).

If MeNB detects UE movement to a new SeNB than the SeNB corresponding to the L-GW indicated as part of L-GW Switch or deactivation described above, the MeNB may inform the MME by using the S1 interface, and the MME can continue to use the last connected L-GW or PGW for reactivation, instead of the new L-GW.

If the new node detected prior to the reactivation has an L-GW connected to it, the MeNB may inform the latest L-GW-IP-Address via a S1 message. The MME may use this L-GW-IP-Address for S5 setup.

Methods such as these described above may be applied in 5G multi connectivity deployments where both 4G-AP and 5G-AP have L-GWs and offloading is needed between the 4G L-GW to the 5G L-GW nodes using the base-line method of IP Session movement of the LTE.

The 5G L-GW may not be directly controllable from the 4G MME node via the usual S5 interface. In such scenarios the SIPTO@LN, or alike service via 5G L-GW, may be managed with help of a 4G MeNB (or 4G macro node) collocated L-GW-proxy function that is capable to control 5G access specific L-GWs.

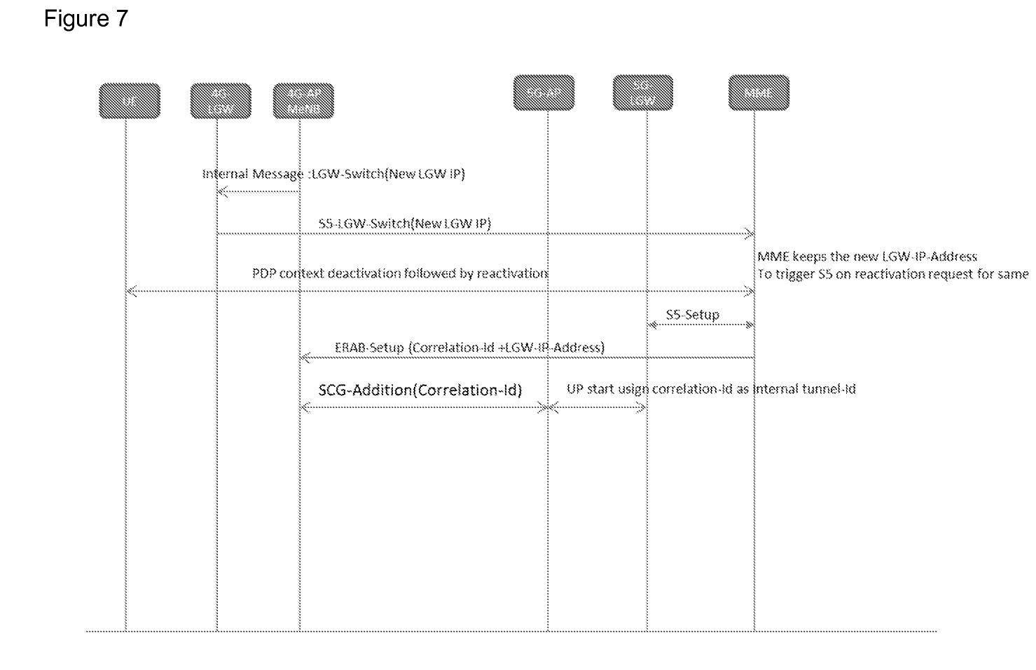

FIG. 7 shows a signalling flowchart for switching of the PDN connection from a L-GW connected to the 4G-AP to a L-GW connected to the 5G-AP. If the 4G-L-GW acts as -L-GW proxy for all the 5G-L-GWs or the 5G-L-GWs are hidden behind a 5G-L-GW proxy ,the messages in the above sequence may also carry additional identifier (such as the above mentioned L-GW-ID) so that the L-GW proxy can route the S5 setup message to the right L-GW. The L-GW-ID in the S1 message towards the MeNB (or 4G-AP) may also help the 4G-AP to identify the target 5G-AP to be added to multi-connectivity.

It should be understood that each block of the flowchart of FIG. 5 or 6 and any combination thereof may be implemented by various means or their combinations, such as hardware, software, firmware, one or more processors and/or circuitry.

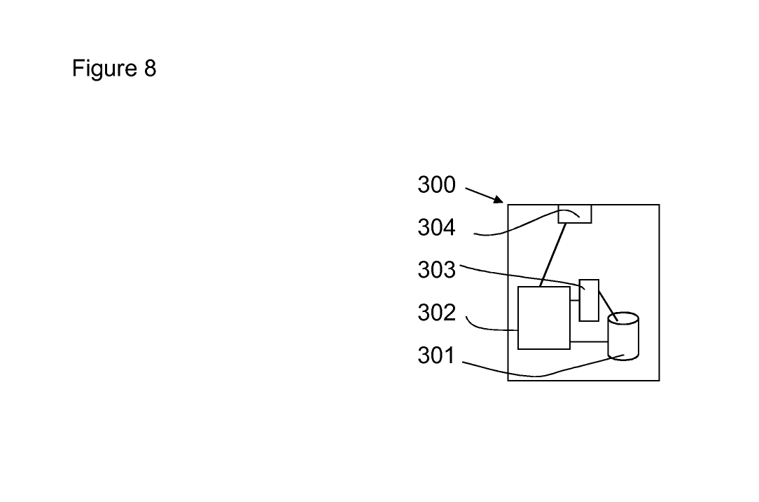

Embodiments described above by means of FIGS. 1 to 7 may be implemented on a control apparatus as shown in FIG. 8 or on a mobile device such as that of FIG. 2. FIG. 8 shows an example of a control apparatus for a communication system, for example to be coupled to and/or for controlling a station of an access system, such as a base station or (e) node B, or a server or host. In some embodiments, base stations comprise a separate apparatus unit or module. In other embodiments, the control apparatus can be another network element such as a radio network controller, MME or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may include receiving information, said information comprising an indication of a first local gateway suitable for providing connectivity to a user equipment, wherein the first local gateway is collocated with a first secondary access point, receiving a request from the user equipment for a packet data network connection, upon the request, using said information to select the first local gateway for providing connectivity to the user equipment and providing an indication of the first local gateway to a master access point.

Alternatively or in addition, control functions may comprise determining, a first local gateway suitable for providing connectivity to a user equipment, wherein the first local gateway is collocated with a first secondary access point and providing information to a node of the core network for use in selecting a local gateway upon a request from the user equipment for a packet data network connection, said information comprising an indication of the determined first local gateway.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE, similar principles can be applied to any other communication system or radio access technology, such as 5G. In addition, while embodiments have been described with reference to SIPTO@ LN as an example, methods may be also be applicable to other suitable offloading schemes, e.g. LIPA. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 7 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 7 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-25. (canceled)

26. A method, comprising:
receiving information, at a node of a core network, said information comprising an indication of a first local gateway suitable for providing connectivity to a user equipment, wherein the first local gateway is collocated with a first secondary access point;
receiving a request from the user equipment for a packet data network connection;
upon the request, using said information to select the first local gateway for providing connectivity to the user equipment; and
providing an indication of the first local gateway to a master access point.

27. An apparatus, comprising:
at least one processor and at least one memory including a computer program code, wherein the at least one memory and the computer program code are configured, with the at least one processor, to cause the apparatus at least to:
receive information said information comprising an indication of a first local gateway suitable for providing connectivity to a user equipment, wherein the first local gateway is collocated with a first secondary access point;
receive a request from the user equipment for a packet data network connection;
upon the request, use said information to select the first local gateway for providing connectivity to the user equipment; and
provide an indication of the first local gateway to a master access point.

28. The apparatus according to claim 27, wherein the at least one memory and the computer program code are configured, with the at least one processor, to cause the apparatus further to:
store said information at a node of a core network at least until the request is received.

29. The apparatus according to claim 27, wherein the at least one memory and the computer program code are configured, with the at least one processor, to cause the apparatus further to:
store user context associated with the user equipment at a node of a core network at least until the request is received.

30. The apparatus according to claim 27, wherein said information comprises mobility information associated with the user equipment.

31. The apparatus according to claim 27, wherein the at least one memory and the computer program code are configured, with the at least one processor, to cause the apparatus further to:
comprise receiving said information from at least one of the master access point and a second local gateway.

32. The apparatus according to claim 31, wherein the second local gateway is collocated with one of the master access point and a second secondary access point.

33. The apparatus according to claim 31, wherein the at least one memory and the computer program code are configured, with the at least one processor, to cause the apparatus further to:
receive a request to offload at least a part of the data communication from the second local gateway, wherein the user equipment has a packet data network connection to be offloaded to the first secondary access point from an access point collocated with the second local gateway.

34. The apparatus according to claim 27, wherein the indication of the first local gateway comprises an identifier of a local gateway acting as a proxy and an identifier of the first local gateway behind the proxy.

35. The apparatus according to claim 27, wherein the request from the user equipment for the packet data network connection is a request for a packet data network reactivation or reattach.

36. An apparatus, comprising:
at least one processor and at least one memory including a computer program code, wherein the at least one memory and the computer program code are configured, with the at least one processor, to cause a master access point at least to:
determine a first local gateway suitable for providing connectivity to a user equipment, wherein the first local gateway is collocated with a first secondary access point; and
provide information to a node of a core network for use in selecting a local gateway upon a request from the user equipment for a packet data network connection, said information comprising an indication of the determined first local gateway.

37. The apparatus according to claim 36, wherein the at least one memory and the computer program code are configured, with the at least one processor, to cause the master access point further to:
provide information to a second local gateway providing connectivity to the user equipment, said information comprising an indication of the determined first local gateway.

38. The apparatus according to claim 37, wherein said information provided to the second local gateway comprises a trigger to offload at least part of a data communication with the user equipment to the determined first local gateway.

39. The apparatus according to claim 37, wherein the second local gateway is collocated with one of the master access point and a second secondary access point.

40. The apparatus according to claim 37, wherein the user equipment has a packet data network connection to be offloaded to the first secondary access point from the access point collocated with the second local gateway.

41. The apparatus according to claim 36, wherein said information provided to the node of the core network comprises mobility information associated with the user equipment.

42. The apparatus according to claim 36, wherein the indication of the determined first local gateway comprises an IP address.

43. The apparatus according to claim 36, wherein the indication of the determined first local gateway comprises an identifier of a local gateway acting as a proxy and an identifier of the first local gateway behind the proxy.

44. The apparatus according to claim 36, wherein the first secondary access point is a 5G access point.

45. The apparatus according to claim 36, wherein the request from the user equipment for the packet data network connection is a request for a packet data network reactivation or reattach.
